(19) United States
(12) Patent Application Publication
(10) Pub. No.: US 2026/0212365 A1
(43) Pub. Date: Jul. 23, 2026

(54) FRAUD DETECTION APPARATUS AND CONTROL METHOD FOR A FRAUD DETECTION APPARATUS

(71) Applicant: Toshiba Tec Kabushiki Kaisha, Tokyo (JP)

(72) Inventors: Yuishi TAKENO, Numazu Shizuoka (JP); Masachika KURATA, Sunto Shizuoka (JP); Keita YAMAZAKI, Mishima Shizuoka (JP)

(21) Appl. No.: 19/423,638

(22) Filed: Dec. 17, 2025

(30) Foreign Application Priority Data
Jan. 22, 2025 (JP) 2025-009270

(51) Int. Cl. G06Q 20/40; G06Q 20/20

(52) U.S. Cl. CPC G06Q 20/4016; G06Q 20/208

(57) ABSTRACT

According to an embodiment, a fraud detection apparatus acquires detection information of a target object from a sensor that detects the target object in a predetermined area of the registration machine. The fraud detection apparatus acquires product registration information from the registration machine. Further, the fraud detection apparatus performs fraud determination with respect to the registration of the product in the registration machine on the basis of the detection information and the product registration information.

### CROSS-REFERENCE TO RELATED APPLICATIONS

This application is based upon and claims the benefit of priority from the prior Japanese Patent Application No. 2025-9270, filed on January 22, 2025, the entire contents of which are incorporated herein by reference.

### FIELD

An embodiment described here generally relates to a fraud detection apparatus and a control method for a fraud detection apparatus.

In commercial facilities such as supermarkets, self-checkout point-of-sale (POS) terminals are used, where customers perform processing from product registration to settlement processing. Some self-checkout POS terminals detect a fraud on the basis of whether or not products are scanned.

In a case where a customer scans products with a registration device other than a fixed scanner, such as a handheld scanner, it may be falsely detected that the products have not been scanned.

### BRIEF DESCRIPTION OF THE DRAWINGS

FIG. 1 is a diagram schematically showing a configuration example of a fraud detection system according to an embodiment.

FIG. 2 is a perspective view showing the outer appearance of a POS terminal according to the embodiment.

FIG. 3 is a top view of the POS terminal according to the embodiment.

FIG. 4 is a block diagram showing main circuit configurations of the POS terminal according to the embodiment.

FIG. 5 is a block diagram showing main circuit configurations of a fraud detection apparatus according to the embodiment.

FIG. 6 is a diagram illustrating a data structure of a product registration information according to the embodiment.

FIG. 7 is a flowchart illustrating an information processing procedure by the fraud detection apparatus according to the embodiment.

FIG. 8 is a flowchart illustrating an information processing procedure related to setting permission information by the fraud detection apparatus according to the embodiment.

FIG. 9 is a flowchart illustrating an information processing procedure related to detecting a fraud by the fraud detection apparatus according to the embodiment.

### DETAILED DESCRIPTION

According to an embodiment, a fraud detection apparatus detects a fraud in a registration machine that stores product registration information in accordance with an operation for registering a product that is a transaction target. The fraud detection apparatus includes a first interface, a second interface, and a processing circuit. The first interface is capable of communicating with a sensor that detects a target object in a predetermined area of the registration machine. The second interface is capable of communicating with the registration machine. The processing circuit acquires detection information of the target object from the sensor via the first interface. The processing circuit acquires the product registration information from the registration machine via the second interface. Further, the processing circuit performs fraud determination with respect to the registration of the product on the basis of the detection information and the product registration information.

Hereinafter, some embodiments will be described with reference to the drawings. In each figure, the same reference signs denote the same or similar portions. It should be noted that in each figure used for the following description of the embodiments, the scales of the respective parts may be modified as appropriate. Moreover, each figure used for the following description of the embodiments may be shown with a configuration(s) omitted for the sake of description.

### Embodiment

Hereinafter, the description will be given, taking a store that sells products as an example. The store is assumed to be a real store. The products are tangible products. A service is a service provided to a customer. A store may be a store that mainly sells tangible products, a store that mainly sells services, or a store that offers both products and services. For example, a store may be a convenience store, a supermarket, a home center, a restaurant, or a gym, though not limited thereto.

A transaction of products or services is a transfer of money from a customer to a store for offering the products or services by the store. The transaction includes the meaning of sale of products from the store's viewpoint. The transaction includes the meaning of purchase of products from the viewpoint of customers.

For example, the store is operated by a business operator. Any genre of the business operator may be employed. For example, the business operator operates a plurality of stores. The business operator includes not only the meaning of the business operator alone but also the meaning of a group of business operators. The group of the business operators is a group that operates stores recognized as a chain. For example, the group of the business operators is a group that operates stores using the same name. The group of the business operators may include franchisees in which a business operator is involved as a franchisor.

### Configuration Example

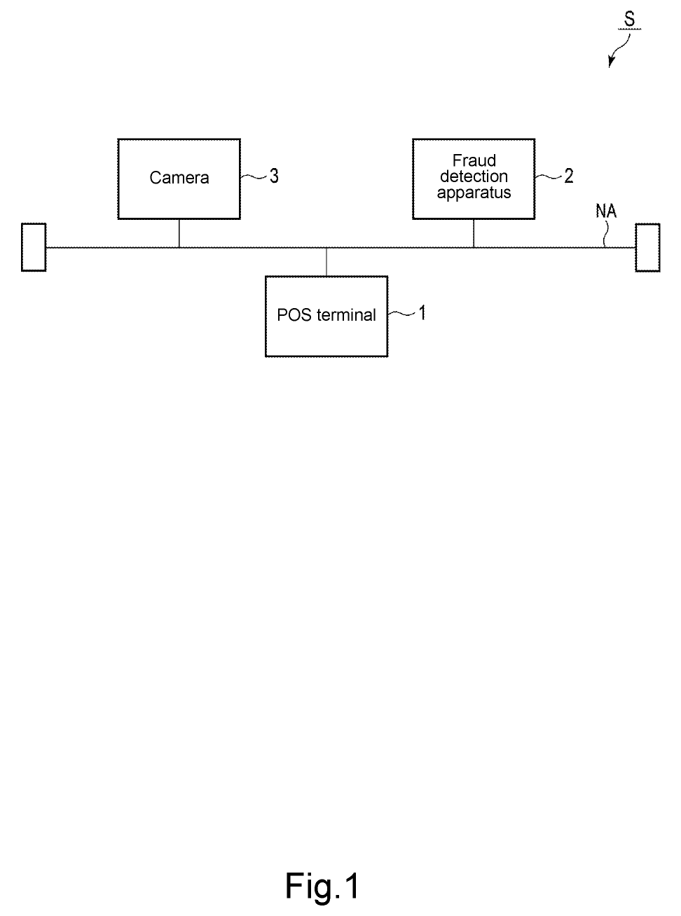

FIG. 1 is a block diagram illustrating a fraud detection system S. The fraud detection system S is a system in a store X. The fraud detection system S includes a POS terminal 1, a fraud detection apparatus 2, and a camera 3. The POS terminal 1, the fraud detection apparatus 2, and the camera 3 are connected to be capable of communicating with each other through a network NA. For example, the network NA is a local area network (LAN), Bluetooth (registered trademark), or Wi-Fi (registered trademark). The network NA may include a wireless network or a wired network. It should be noted that the fraud detection apparatus 2 and the camera 3 may be physically connected to each other by a universal serial bus (USB) or other means.

The fraud detection system S may also refer to a system including at least two of the POS terminal 1, the fraud detection apparatus 2, and the camera 3. The apparatus includes the meaning of an electronic apparatus. It should be noted that the POS terminal 1 and the fraud detection apparatus 2 are physically common and may operate on the same hardware. In this case, the functions realized by processors of the POS terminal 1 and the fraud detection apparatus 2 may be realized by a single apparatus.

FIG. 1 shows an example in which the fraud detection system S includes one POS terminal 1, but the fraud detection system S may have a plurality of POS terminals including the POS terminal 1. The configuration of the plurality of POS terminals can be similar to that of POS terminal 1. FIG. 1 shows an example in which the fraud detection system S includes one camera 3, but the fraud detection system S may have a plurality of cameras including the camera 3. The configuration of the plurality of cameras can be similar to that of the camera 3.

The POS terminal 1 is an apparatus that processes transactions in the store X. The POS terminal 1 is mainly used by a customer in the store X. The customer may be read as a user, an operator, or a person. For example, the POS terminal 1 has a product registration function. With the product registration function, the POS terminal 1 processes the registration of one or more products that are transaction targets. The POS terminal 1 is an example of a registration machine.

Hereinafter, the registration of the products will be also referred to as product registration. The products that are the transaction targets will be also referred to as transaction target products. The product registration means registering products as transaction target products. For example, the product registration includes adding data related to the transaction target product to data related to the transaction. The adding the data includes recording data. The data related to the transaction can include the data related to the transaction target product for each transaction target product for a single transaction. Hereinafter, the data related to the transaction will be referred to as product registration information. The data related to the transaction target product is data about the details of the transaction target product. The data related to the transaction target product will be also referred to as transaction target product data. The transaction target product data is an example of the product registration information about the transaction target product.

The transaction target product data includes all or some of registration date and time, a registration device, a product code of the transaction target product, a name of the transaction target product, a price of the transaction target product, the number of transaction target products, and an amount of the transaction target product. Information related to the transaction target product may also include information other than those information. The registration date and time is information indicating date and time at which the transaction target product was registered via the registration device. For example, the registration date and time may be date and time at which the product code of the transaction target product was read via the registration device. The registration device is information indicating the registration device to which the transaction target product was registered. The information indicating the registration device may be information indicating the type of the registration device to which the transaction target product was registered. For example, the type of the registration device includes a fixed scanner, a handheld scanner, and a touch panel. The fixed scanner is arranged inside the main body of the POS terminal 1. The fixed scanner reads a barcode indicated on a product held by the operator in front of a scanner window. The handheld scanner is used in a state of being held by the operator. The handheld scanner reads the barcode indicated on the product that the operator brings close to the handheld scanner. The touch panel accepts a touch operation from the operator. The touch operation includes an operation of selecting a transaction target product from a list of products displayed on the touch panel. The information about the registration device may include registration device identification information capable of identifying the registration device. The registration device is an example of a registration unit.

The product code of the transaction target product is identification information capable of uniquely identifying the transaction target product. For example, the product code is a Japanese article number (JAN) code. The name of the transaction target product is a product name of the transaction target product or the like. The price of the transaction target product is a price per one transaction target product. The number of transaction target products is the number of transaction target products included in one transaction. The amount of the transaction target product is a sum of prices for the number of transaction target products. The name of the product will be also referred to as a product name.

The product registration information may include a payment amount. The payment amount is the amount of payment for the transaction paid by a settlement method selected by the customer. The payment amount is the same amount as the invoice amount.

For example, the product registration information is stored in a transaction management server that manages each transaction. The transaction management server may be the fraud detection apparatus 2 or may be a server different from the fraud detection apparatus 2. The transaction management server may be a server that is used for a cloud service.

For example, the POS terminal 1 has a function of settlement. With the settlement function, the POS terminal 1 processes the settlement of the transaction on the basis of the product registration information. The settlement is payment for the transaction. The settlement includes the meaning of accounting. The completion of the settlement by POS terminal 1 includes the meaning of the conclusion of the transaction.

A settlement method for the settlement of the transaction includes offline settlement and online settlement. The offline settlement is a settlement that does not require the POS terminal 1 to be linked to other apparatuses via the network NA. For example, the offline settlement is a settlement by cash, gift card, etc. The online settlement is a settlement that is executed by the POS terminal 1 in cooperation with other apparatuses via the network NA. For example, the online settlement is credit card settlement, electronic money settlement, debit card settlement, or code settlement.

The POS terminal 1 is mainly operated by a customer operation. According to an operation by the operator, the POS terminal 1 processes the transaction by performing registration processing related to the registration of the products that are the transaction targets and settlement processing related to the accounting of the prices for the registered products.

The fraud detection apparatus 2 is an apparatus capable of communicating with the POS terminal 1 and the camera 3 via the network NA. In a case where the fraud detection system S includes a plurality of POS terminals, the fraud detection apparatus 2 is an apparatus capable of communicating with the plurality of POS terminals including the POS terminal 1 via the network NA. In a case where the fraud detection system S includes a plurality of cameras, the fraud detection apparatus 2 is an apparatus capable of communicating with the plurality of cameras including the camera 3 via the network NA.

The fraud detection apparatus 2 may be a dedicated apparatus or may be a desktop personal computer (PC), a laptop PC, a tablet PC, a smartphone, or the like. The fraud detection apparatus 2 is an example of an information processing apparatus that processes information for detecting a fraud in the product registration.

For example, the camera 3 is an overhead camera installed on the top of the POS terminal 1. The camera 3 captures an overhead image of an imaging region. For example, the imaging region is a region including the POS terminal 1 and the operator of the POS terminal 1. For example, the camera 3 obtains a captured image by imaging a target object from above. For example, the target object includes a hand of the operator of the POS terminal 1. For example, the target object includes an object such as a product that is registered by the POS terminal 1. The camera 3 includes an imaging device such as a video camera or a still camera. The camera 3 is an example of an imaging unit that images the imaging region. The camera 3 outputs the captured image to the fraud detection apparatus 2. The captured image shows a moving image constituted by consecutive captured images obtained in a time series on the basis of the imaging by the camera 3. The camera 3 is an example of a sensor that detects a target object. The captured image is an example of detection information of the target object.

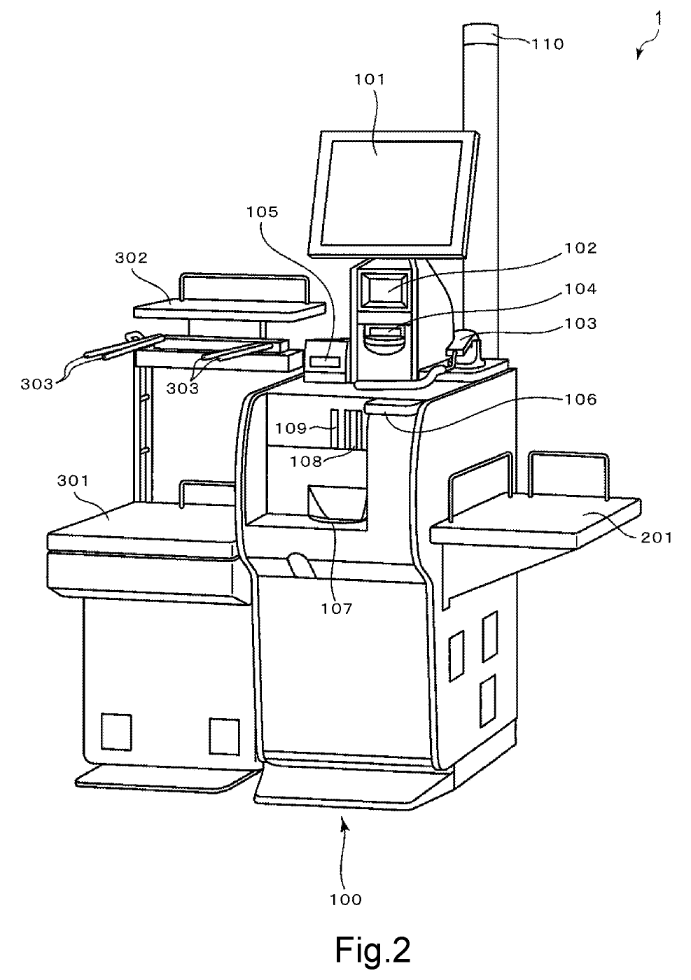

FIG. 2 is a perspective view showing the outer appearance of the POS terminal 1 according to the embodiment. It should be noted that the POS terminal 1 is also called a self-checkout POS terminal, a checkout apparatus, or a self-checkout apparatus.

The POS terminal 1 includes a main body 100, a table 201 for placing unregistered products, a table 301 for placing registered products, a table 302 for temporarily placing the registered products, and an arm 303 for hanging bags in which the registered products are put. The table 201 for placing unregistered products will be also referred to as a shopping basket table. The table 301 for placing registered products will be also referred to as a bagging table. The table 302 for temporarily placing the registered products will be also referred to as a temporary table.

The main body 100 includes a touch panel 101, a scanner window 102, a handheld scanner 103, a receipt issuing slot 104, a card insertion slot 105, a coin insertion slot 106, a change slot 107, a banknote insertion slot 108, a banknote ejection slot 109, and an alarm lamp 110.

The touch panel 101 displays various screens to inform the operator of various types of information. Some of the various screens constitute a graphical user interface (GUI), and the touch panel 101 receives touch operations to operate the GUI. That is, the touch panel 101 is both a display device and an input device.

The scanner window 102 is formed by covering an opening formed in the main body 100 with a transparent resin or glass. The scanner window 102 allows a product held by the operator in front of the scanner window 102 to be scanned by a fixed scanner arranged inside the main body 100.

The handheld scanner 103 reads a barcode indicated on the product when it is held by the operator and brought close to the barcode, and outputs barcode information represented by the barcode.

The receipt issuing slot 104 is a slit-like opening for ejecting receipts to the outside of the main body 100.

The card insertion slot 105 is a slit-like opening for inserting a credit card inserted by the operator for settlement into the inside of the main body 100.

The coin insertion slot 106 receives coins that are thrown in by the operator. The bottom surface of the coin insertion slot 106 has an opening, and the coins received by the coin insertion slot 106 are taken into the inside of the main body 100 through the opening.

The change slot 107 receives coins ejected from the main body 100 as change or the like.

The banknote insertion slot 108 is a slit-like opening to take banknotes inserted by the operator into the inside of the main body 100.

The banknote ejection slot 109 is a slit-like opening for ejecting banknotes as change or the like from the main body 100. The banknote ejection slot 109 holds the banknotes in a state in which they are partly projected outside of the main body 100.

The alarm lamp 110 lights up and blinks for various alarms.

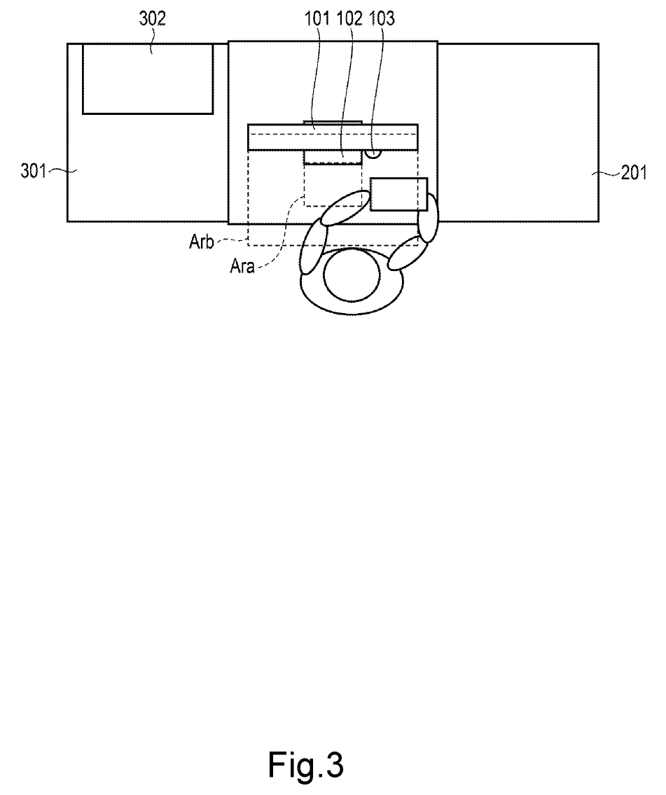

FIG. 3 is a top view of the POS terminal 1 according to the embodiment. FIG. 3 is a top view in a case where the operator is registering a product with the POS terminal 1. The operator stands in front of the POS terminal 1 and registers the product. The operator stands facing the front of the main body 100 of the POS terminal 1 and performs a product registration operation. The product registration operation includes an operation of scanning products via a fixed scanner 115. The product registration operation includes an operation of scanning products via the handheld scanner 103. The product registration operation includes an operation of inputting information about transaction target products via the touch panel 101. The shopping basket table 201 is located on the right side of the main body 100 and the bagging table 301 and the temporary table 302 are located on the left side of the main body 100. When registering a product, the operator moves the product from the shopping basket table 201 toward the bagging table 301 and the temporary table 302. The position of the shopping basket table 201 with respect to the main body 100 will be also referred to as an upstream side. The positions of the bagging table 301 and the temporary table 302 with respect to the main body 100 will be also referred to as a downstream side. For example, when registering a product, the operator moves the product from the upstream side to the downstream side.

The main body 100 of the POS terminal 1 includes a readable area Ara and a passage detection area Arb. The readable area Ara is a region where the fixed scanner can read the barcode when the operator holds the barcode of the product over the scanner window 102. The passage detection area Arb is a region where the camera 3 or the like can detect a target object. For example, the passage detection area Arb is a region capable of detecting the passage of the product when the operator moves the product from the upstream side to the downstream side. The passage detection area Arb may be the same area as the readable area Ara or may be a region wider than the readable area Ara. The passage detection area Arb may be the same region as the imaging region of the camera 3 or may be a region narrower than the imaging region.

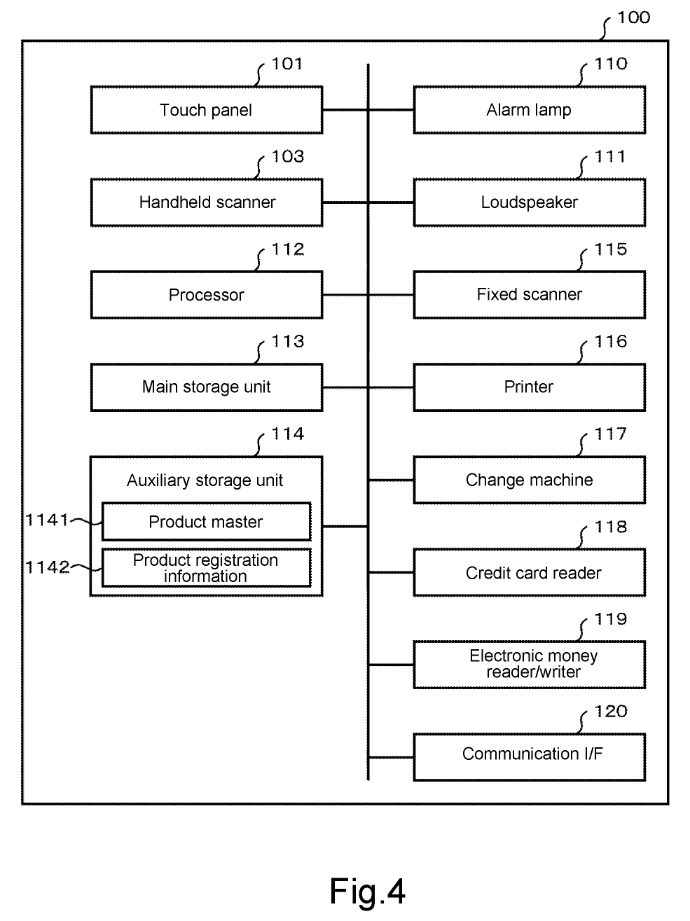

FIG. 4 is a block diagram showing main circuit configurations of the POS terminal 1. It should be noted that the same elements as those shown in FIG. 2 will be denoted by the same reference signs in FIG. 4, and the detailed descriptions thereof will be omitted.

In addition to the above-mentioned touch panel 101, handheld scanner 103, and alarm lamp 110, the main body 100 includes a loudspeaker 111, a processor 112, a main storage unit 113, an auxiliary storage unit 114, the fixed scanner 115, a printer 116, a change machine 117, a credit card reader 118, an electronic money reader/writer 119, and a communication interface 120.

The processor 112, the main storage unit 113, and the auxiliary storage unit 114 are connected by a communication channel to constitute a computer for controlling the POS terminal 1.

The processor 112 corresponds to a central part of the POS terminal 1. The processor 112 is an element that constitutes the computer of the POS terminal 1. For example, the processor 112 is a central processing unit (CPU) or a graphics processing unit (GPU), though not limited thereto. The processor 112 executes information processing to control the respective units to realize various functions of the POS terminal 1 on the basis of various information processing programs such as operating systems, firmware, and application programs stored in the main storage unit 113 and the auxiliary storage unit 114.

The processor 112 is an example of a processing circuit that executes a plurality of processes by a plurality of functions. The processing circuit includes one or more circuits that execute a plurality of processes by a plurality of functions. For example, the circuit is a processor, an application specific integrated circuit (ASIC), or a field-programmable gate array (FPGA), though not limited thereto.

The main storage unit 113 corresponds to the main storage part of the above-mentioned computer. The main storage unit 113 includes a read-only memory area and a rewritable memory area. The main storage unit 113 stores a part of the above-mentioned information processing program in the read-only memory area. Moreover, the main storage unit 113 may also store data necessary for the processor 112 to execute processes to control the respective units in the read-only memory area or the rewritable memory area. The main storage unit 113 uses the rewritable memory area as a work area for the processor 112.

The auxiliary storage unit 114 corresponds to the auxiliary storage part of the above-mentioned computer. For example, the auxiliary storage unit 114 includes well-known storage devices such as an EEPROM (registered trademark) (electric erasable programmable read-only memory), a hard disc drive (HDD), and a solid state drive (SSD). The auxiliary storage unit 114 saves data that is used for the processor 112 to perform various types of processing and data generated in processing at the processor 112. The auxiliary storage unit 114 may also store application programs.

The auxiliary storage unit 114 stores a product master 1141. The product master 1141 includes product information about each product. The product information includes various types of information about a product, such as product code, product identification information, price, and product name. The data in the product master 1141 can be updated every time the product information is added, deleted, or updated.

The auxiliary storage unit 114 stores product registration information 1142. The product registration information 1142 includes product registration information for each transaction. The product registration information includes all or some of the registration date and time, the registration device, the product code of the transaction target product, the name of the transaction target product, the price of the transaction target product, the number of transaction target products, and the amount of the transaction target product.

The loudspeaker 111 is a device capable of outputting sounds under the control of the POS terminal 1. The loudspeaker 111 is an example of an audio output device.

The fixed scanner 115 acquires a product code for identifying a product. The fixed scanner 115 captures a barcode, two-dimensional code, or the like held in front of the scanner window 102, and identifies the data represented by the barcode or two-dimensional code by image processing. The fixed scanner 115 optically reads the barcode, two-dimensional code, or the like held in front of the scanner window 102 by using laser light or the like. The fixed scanner 115 may identify products by using an object recognition technique based on image features of the product itself. The fixed scanner 115 may acquire data stored in a wireless tag by wireless communication.

The printer 116 includes a receipt printer and a journal printer. The receipt printer issues various vouchers by printing various types of information on receipt paper. The various vouchers include receipts that show the details of business transactions, credit slips related to credit card settlement, and the like. The vouchers issued by the receipt printer are ejected from the receipt issuing slot 104 to the outside of the main body 100. The journal printer prints, on journal paper, journal data containing information printed on the receipt paper by the receipt printer. The journal paper is kept inside the main body 100 unless it is removed by a maintainer.

The change machine 117 includes coin storage that stores coins by their denominations and banknote storage that stores banknotes by their denominations. The change machine 117 takes coins thrown in the coin insertion slot 106, identifies the denomination of the coins, and stores them in the coin storage by their denominations. The change machine 117 takes in banknotes inserted into the banknote insertion slot 108, identifies the denomination of the banknotes, and stores them in the banknote storage by their denominations. The change machine 117 ejects coins or banknotes stored in the coin or banknote storage from the change slot 107 or the banknote ejection slot 109 in accordance with a withdrawal command from the processor 112. As such a change machine 117, a well-known automatic change machine can be applied.

The credit card reader 118 reads data recorded on a credit card inserted by an operator into the card insertion slot 105. The credit card reader 118 corresponds to a reading device.

For example, the electronic money reader/writer 119 includes a NFC near field communication) communication unit and reads data from a nearby electronic money card via wireless communication. The electronic money reader/writer 119 writes data from a nearby electronic money card via wireless communication.

The communication interface 120 includes various interfaces that connect the POS terminal 1 to other apparatuses via a network in accordance with a predetermined communication protocol. For example, the communication interface 120 connects the POS terminal 1 to an external apparatus via the network NA.

It should be noted that the hardware configuration of POS terminal 1 is not limited to the above-mentioned configuration. The POS terminal 1 can omit or change the above-mentioned components or add new components as appropriate.

Product registration processing by the processor 112 will be described. For example, the processor 112 performs the product registration processing on the basis of the user's operation of the POS terminal 1. Specifically, the processor 112 refers to the product master on the basis of the fact that the product code of the transaction target product is scanned by the user via the fixed scanner 115 or the handheld scanner 103, and obtains product information of the product corresponding to the product code. The product information includes data about the product code, the product name, the product price, and the like. The product corresponding to the product code will be also referred to as the transaction target product. The processor 112 acquires the product information of the product corresponding to the product code by referring to the product master on the basis of the fact that the user operates the touch panel 101 and inputs the information about the transaction target product by selecting a preset key and the like.

It should be noted that the processor 112 may perform the product registration processing in cooperation with a server such as a store server or a cloud server. In this case, the processor 112 outputs a product registration request to the server. The server acquires product information from the product master on the basis of the product code included in the product registration request and stores registration product information as product information. The server outputs the registration product information to the POS terminal 1. The processor 112 stores the registration product information.

The processor 112 stores the product information of the transaction target product in the auxiliary storage unit 114 as the registration product information. The processor 112 saves information indicating the registration date and time in the auxiliary storage unit 114 as the registration product information. The processor 112 saves information indicating the registration device as the registration product information in the auxiliary storage unit 114. The information indicating the registration device indicates the type of the registration device scanned by the product code of the transaction target product. In a case where the product code of the transaction target product is scanned by the user via the fixed scanner 115, the processor 112 stores information indicating the "fixed scanner" as the information indicating the registration device. In a case where the product code of the transaction target product is scanned by the user via the handheld scanner 103, the processor 112 saves information indicating the "handheld scanner" as the information indicating the registration device. In a case where the information about the transaction target product is input by the user via the touch panel 101, the processor 112 stores information indicating the "touch panel" as the information indicating the registration device.

It should be noted that the processor 112 may acquire the product code of the transaction target product by the user scanning a RFID tag via an RFID reader and acquire the product information of the product corresponding to the product code. In this case, the processor 112 may save information indicating the "RFID reader" as the information indicating the registration device. It should be noted that the processor 112 may acquire the product information of the product on the basis of an image of the product captured by the user with the camera. In this case, the processor 112 may save the information indicating the "camera" as the information indicating the registration device.

The processor 112 outputs the registration product information of the transaction target product to the fraud detection apparatus 2 every time the transaction target product is registered.

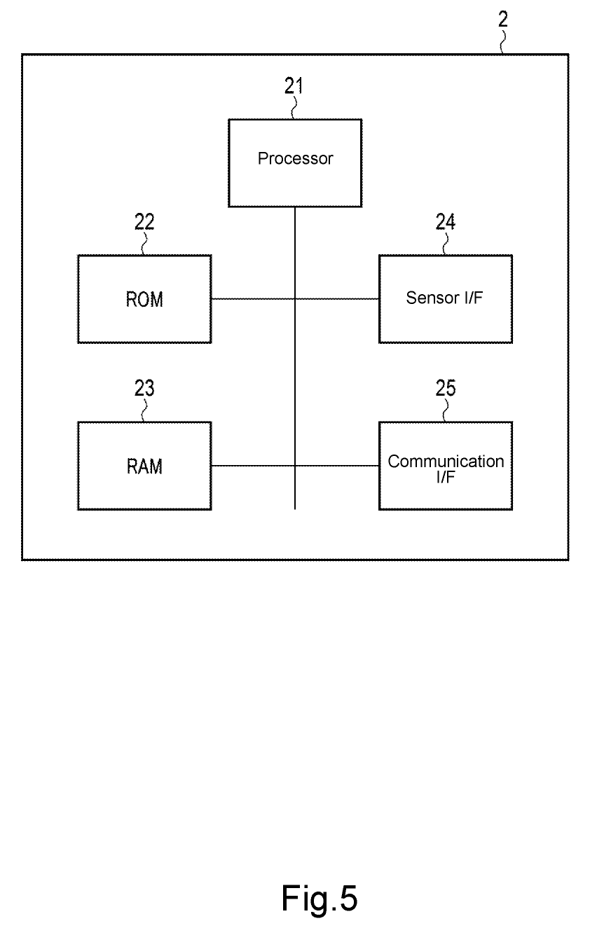

FIG. 5 is a block diagram showing main circuit configurations of the fraud detection apparatus 2 according to the embodiment.

The fraud detection apparatus 2 includes a processor 21, a read only memory (ROM) 22, a random access memory (RAM) 23, a sensor interface 24, and a communication interface 25, and the like.

The processor 21 is connected to be capable of communicating with the ROM 22, the RAM 23, the sensor interface 24, and the communication interface 25.

The processor 21 corresponds to a central part of the fraud detection apparatus 2. The processor 21 is an element that constitutes the computer of the fraud detection apparatus 2. The processor 21 expands the program stored in the ROM 22 to the RAM 23. The processor 21 executes the program that is expanded in the RAM 23 to enable the execution of various types of processing. For example, the processor 21 is a CPU or a GPU, though not limited thereto.

The processor 21 is an example of a processing circuit that executes a plurality of processes by a plurality of functions. The processing circuit includes one or more circuits that execute the plurality of processes by the plurality of functions.

The ROM 22 is a nonvolatile memory in which control programs, control data, and the like are prestored. The control program and control data stored in the ROM 22 are prestored according to the specifications of the fraud detection apparatus 2.

The RAM 23 is a volatile memory. The RAM 23 temporarily stores the data and the like that are being processed by the processor 21. The RAM 23 stores various application programs on the basis of commands from the processor 21. Moreover, the RAM 23 may store data necessary for the execution of application programs, the results of the execution of application programs, and the like.

For example, the RAM 23 stores the product registration information. For example, the processor 21 acquires the product registration information from the POS terminal 1 via the communication interface 25 every time a product registration is performed at the POS terminal 1. The processor 21 saves the product registration information in the RAM 23 every time the processor 21 acquires the product registration information.

For example, the RAM 23 stores permission information. The permission information is information used for fraud determination in the product registration. The fraud determination means determining product registration omissions. For example, in a case where there is a product registration omission, the fraud determination includes determining that there is a fraud. In a case where there are no product registration omissions, the fraud determination includes determining that there is no fraud. The permission information is an example of a determination condition of the fraud determination. The determination condition of the fraud determination will be also referred to as a fraud determination condition. The fraud determination condition is a condition for determining that there is a fraud with respect to the product registration. The fraud determination condition includes determining that there is a fraud. For example, the fact that no permission information is set is an example of a fraud determination condition related to the permission information. The fraud detection apparatus 2 sets the permission information on the basis of the product registration information. For example, the permission information is information for permitting the entry and exit of the target object to/from the predetermined area. The permitting includes not determining that there is a fraud. For example, the predetermined area is a passage detection area. The predetermined area may be a readable area. The predetermined area can be preset by a manager or the like. The permission information is information that is set when a product is registered by a registration device other than the fixed scanner. The permission information may be information indicating that the product is registered by the registration device other than the fixed scanner. The permission information may be information indicating that the entry and exit of the target object to/from the predetermined area are permitted. For example, in a case where the permission information is set, the fraud detection apparatus 2 does not perform the fraud determination also in a case where there is no product registration information between the entry and exit of the target object to/from the predetermined area.

For example, the permission information is a permission flag. For example, the permission flag is a flag indicating that the entry and exit of the target object to/from the predetermined area are permitted. The permission flag may be a flag indicating that the product is registered by the registration device other than the fixed scanner. The permission flag is one-bit information for identifying whether or not to permit the entry and exit of the target object to/from the predetermined area. The permission flag may be one-bit information for identifying whether or not the product is registered by the registration device other than the fixed scanner. For example, in a case where the fraud detection apparatus 2 permits the entry and exit of the target object to/from the predetermined area, the fraud detection apparatus 2 sets the permission flag. The setting the permission flag includes setting the permission flag to "1." Setting the permission flag is an example of setting the permission information. In a case where the entry and exit of the target object to/from the predetermined area are permitted, the fraud detection apparatus 2 clears the permission flag. The clearing the permission flag includes setting the permission flag to "0." The fraud detection apparatus 2 may set the permission flag in a case where the product is registered by the registration device other than the fixed scanner. In a case where the product is registered by the fixed scanner, the fraud detection apparatus 2 may clear the permission flag.

The sensor interface 24 is connected to be capable of communicating with the camera 3 that detects the target object. For example, on the basis of the control of the processor 21, the sensor interface 24 sends a signal to instruct the camera 3 to perform imaging. Moreover, the sensor interface 24 acquires captured image obtained by imaging from the camera 3. For example, the sensor interface 24 may support universal serial bus (USB) connection or may support camera link connection. The sensor interface 24 is an example of a first interface.

The communication interface 25 is an interface for sending and receiving data to and from the external apparatus. The communication interface 25 connects to the external apparatus via a network or the like. For example, the communication interface 25 supports wired or wireless LAN connection. The communication interface 25 is connected to be capable of communicating with the POS terminal 1. The communication interface 25 is an example of a second interface.

It should be noted that the hardware configuration of the fraud detection apparatus 2 is not limited to the above-mentioned configuration. The fraud detection apparatus 2 can omit or change the above-mentioned components and add new components as appropriate.

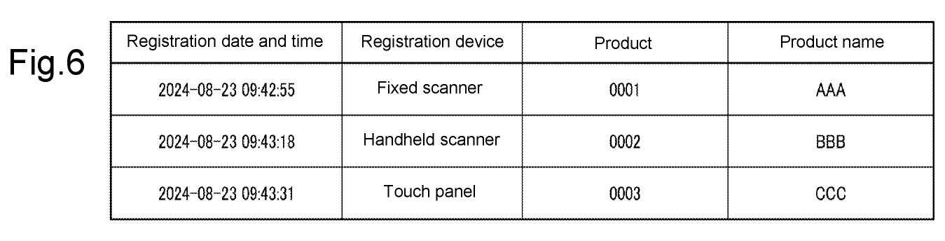

FIG. 6 is a view illustrating a data structure of the product registration information according to the embodiment. The product registration information includes a product registration information record for each registration product. The registration product indicates the registered product. The registration product will be also referred to as a transaction target product. The product registration information record includes the registration date and time, the registration device, the product code, the name of the product, and the like. The product registration information is updated every time the transaction target product is registered at the POS terminal 1. The product registration information is updated every time the fraud detection apparatus 2 acquires the product registration information from the POS terminal 1. It should be noted that the product registration information only needs to at least include the registration date and time and the information indicating the registration device for each registration product. The product registration information may include information other than the registration date and time, the registration device, the product code, and the name of the product.

FIG. 6 shows that the product "AAA" was registered on "August 23, 2024, 9:42:55" using the "fixed scanner." FIG. 6 shows that the product "BBB" was registered on "August 23, 2024, 9:43:18" using the "handheld scanner." FIG. 6 shows that the product "CCC" was registered on the registration date and time of "August 23, 2024, 9:43:31" using the "touch panel." According to this example, the product registration information includes the information indicating the type of the registration device of the product. Therefore, on the basis of the product registration information, the fraud detection apparatus 2 is capable of determining whether the product was registered by the registration device other than the fixed scanner.

### Processing Example

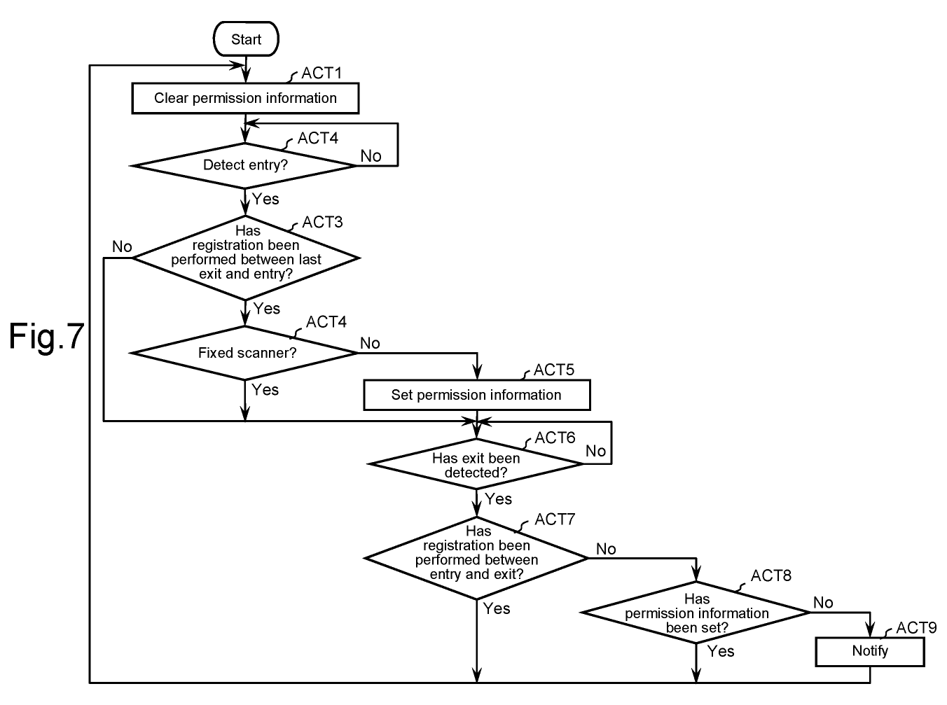

Processing in the fraud detection apparatus 2 will be described. It should be noted that the processing procedure described below is merely an example, and each process may be modified as much as possible. Moreover, the steps may be omitted, substituted, or added as appropriate in accordance with the embodiment with respect to the processing procedure described hereinafter. FIG. 7 is a flowchart illustrating the information processing procedure of the fraud detection apparatus 2 according to the embodiment.

The processing hereinafter is executed on the basis of the registration of the product started by the operator of the POS terminal 1. The start of the registration of the product may be read as the start of one transaction. For example, the processor 21 detects a product registration start trigger. The processor 21 may acquire a start instruction on the basis of the input of the start instruction on the touch panel 101 by the operator of the POS terminal 1. The processor 21 may detect the product registration start trigger on the basis of the fact that the start instruction has been acquired.

The processor 21 starts fraud detection processing on the basis of the detection of the product registration start trigger. The processor 21 clears the permission information (ACT 1). In ACT 1, for example, the processor 21 clears the permission flag stored in the RAM 23.

The processor 21 acquires a captured image from the camera 3 via the sensor interface 24. For example, the processor 21 acquires a moving image. The moving image acquired by the processor 21 is a moving image constituted by consecutive captured images obtained in a time series by the camera 3 on the basis of the imaging.

The processor 21 detects the entry of the target object to the predetermined area on the basis of the captured image acquired from the camera 3 (ACT 2). In ACT 2, for example, the processor 21 determines whether or not the target object has entered from the upstream side of the predetermined area on the basis of the captured image. In a case of detecting that the target object has entered from the upstream side of a region of the captured image, which corresponds to the predetermined area, the processor 21 determines that the processor 21 has detected the entry of the target object to the predetermined area.

In an example, the target object is a hand of the operator of the POS terminal 1. For example, the processor 21 performs image recognition on the basis of the captured image. On the basis of a result of the image recognition, the processor 21 determines whether or not the hand of the operator of the POS terminal 1 has entered from the upstream side of the region of the captured image, which corresponds to the predetermined area. According to this example, the processor 21 is capable of performing the fraud determination on the basis of the detection result of the hand of the operator. Therefore, the processor 21 can suitably perform the fraud detection on the basis of the fact that the hand of the operator has passed the predetermined area.

In another example, the target object is a hand of the operator of the POS terminal 1 holding the product. For example, the processor 21 performs image recognition on the basis of the captured image. For example, the processor 21 recognizes the shape of the hand by image recognition. The processor 21 may recognize the shape of the hand and the object by image recognition. The processor 21 determines whether or not the hand of the operator of the POS terminal 1 is holding the object on the basis of a result of the image recognition. The processor 21 determines whether or not it has entered from the upstream side of the region of the captured image, which corresponds to the predetermined area, in a state in which the hand of the operator of the POS terminal 1 is holding the object. According to this example, the processor 21 is capable of performing the fraud determination on the basis of the detection result of the hand holding the object. Therefore, the processor 21 can be prevented from falsely detecting a fraud in a case where the operator is not holding the product.

In still another example, the target object is an object such as a product. For example, the processor 21 performs image recognition on the basis of the captured image. For example, the processor 21 recognizes whether the object is a product by image recognition. On the basis of a result of the image recognition, the processor 21 determines whether or not the product has entered from the upstream side of the region of the captured image, which corresponds to the predetermined area. According to this example, the processor 21 is capable of performing the fraud determination on the basis of the detection result of the product. Therefore, the processor 21 can be prevented from falsely detecting a fraud in a case where the product has passed the predetermined area. It should be noted that the target object may be an object held by the operator of the POS terminal 1. In this case, for example, the processor 21 recognizes the object held by the operator by image recognition. The processor 21 may be recognize the shape of the hand and the object by image recognition. On the basis of a result of the image recognition, the processor 21 determines whether or not the product held by the operator has entered from the upstream side of the region of the captured image, which corresponds to the predetermined area. According to this example, the processor 21 is capable of performing the fraud determination on the basis of the detection result of the product held by the operator. Therefore, the processor 21 can be prevented from falsely detecting a fraud in a case where the product held by the operator has passed the predetermined area.

In a case where the processor 21 has detected the entry of the target object to the predetermined area (ACT 2: YES), the processing shifts from ACT 2 to ACT 3. In a case where the processor 21 has not detected the entry of the target object to the predetermined area (ACT 2: NO), ACT 2 is repeated as the processing.

The processor 21 determines whether or not the product has been registered between the last exit and the current entry (ACT 3). In ACT 3, for example, the processor 21 determines whether or not there is product registration information registered between a point in time at which the processor 21 has detected that the current target object has exited the predetermined area and a point in time at which the processor 21 has detected that the current target object has entered the predetermined area. The current target object means a target object detected one before the object detected in ACT 2 in one transaction. The current target object means the target object detected in ACT 2. The detection of the exit of the target object from the predetermined area includes determining whether or not the target object has exited from the downstream side of the region of the captured image, which corresponds to the predetermined area. The point in time at which the processor 21 has detected that the target object has entered the predetermined area will be also referred to as an entry detection time. The point in time at which the processor 21 has detected that the target object has exited the predetermined area will be also referred to as an exit detection time. For example, the processor 21 acquires the product registration information stored in the RAM 23. The processor 21 determines whether or not the product registration has been performed between the exit detection time of the current target object and the entry detection time of the current target object on the basis of the product registration information. It should be noted that in a case where there is no current target object, the processor 21 may determine whether or not there is product registration information before the detection of the current entry of the target object to the predetermined area.

In a case where there is product registration information registered between the exit detection time of the current target object and the entry detection time of the current target object, the processor 21 determines that the product has been registered between the last exit and the current entry. In a case where there is no product registration information registered between the exit detection time of the current target object and the entry detection time of the current target object, the processor 21 determines that the product has not been registered between the last exit and the current entry.

In a case where the product has been registered between the last exit and the current entry (ACT 3: YES), the processing shifts from ACT 3 to ACT 4. In a case where the product has not been registered between the last exit and the current entry (ACT 3: NO), the processing shifts from ACT 3 to ACT 6.

The processor 21 determines whether or not the registration device is the fixed scanner on the basis of the fact that the product has been registered between the last exit and the current entry (ACT 4). In ACT 4, for example, the processor 21 refers to the product registration information in which the product has been registered between the last exit and the current entry. The processor 21 determines the type of the registration device on the basis of the product registration information. In a case where the type of the registration device is the fixed scanner, the processor 21 determines that the registration device is the fixed scanner. In a case where the type of the registration device is a registration device different from the fixed scanner, the processor 21 determines that the registration device is not the fixed scanner.

In a case where the registration device is the fixed scanner (ACT 4: YES), the processing shifts from ACT 4 to ACT 6. In a case where the registration device is not the fixed scanner (ACT 4: NO), the processing shifts from ACT 4 to ACT 5.

The processor 21 sets the permission information on the basis of the fact that the registration device is not the fixed scanner (ACT 5). In ACT 5, for example, the processor 21 sets the permission flag. The processor 21 saves the permission flag in the RAM 23.

The processor 21 detects the exit of the target object from the predetermined area on the basis of the captured image acquired from the camera 3 (ACT 6). In ACT 6, for example, the processor 21 determines whether or not the target object has exited from the downstream side of the predetermined area on the basis of the captured image. For example, the processor 21 performs image recognition on the basis of the captured image. On the basis of a result of the image recognition, the processor 21 determines whether or not the target object has exited from the downstream side of the region of the captured image, which corresponds to the predetermined area.

In a case where the processor 21 has detected the exit of the target object from the predetermined area (ACT 6: YES), the processing shifts from ACT 6 to ACT 7. In a case where the processor 21 has not detected the exit of the target object from the predetermined area (ACT 6: NO), ACT 6 is repeated as the processing.

The processor 21 determines whether or not the product has been registered between the entry and the exit of the target object (ACT 7). In ACT 7, for example, the processor 21 determines whether or not there is product registration information registered between the entry detection time of the current target object and the exit detection time of the current target object. For example, the processor 21 acquires the product registration information stored in the RAM 23. The processor 21 determines whether or not the product registration has been performed between the entry detection time of the current target object and the exit detection time of the current target object on the basis of the product registration information.

In a case where there is product registration information registered between the entry detection time of the current target object and the exit detection time of the current target object, the processor 21 determines that the product has been registered between the entry and the exit of the target object. In a case where there is no product registration information registered between the entry detection time of the current target object and the exit detection time of the current target object, the processor 21 determines that the product has not been registered between the entry and the exit of the target object. For example, the fact that the product has not been registered between the entry and the exit of the target object is an example of a fraud determination condition related to the product registration information.

In a case where the product has been registered between the entry and the exit of the target object (ACT 7: YES), the processing shifts from ACT 7 to ACT 1. In a case where the product has not been registered between the entry and the exit of the target object (ACT 7: NO), the processing shifts from ACT 7 to ACT 8.

The processor 21 determines whether or not the permission information has been set on the basis of the fact that the product has not been registered between the entry and the exit of the target object (ACT 8). In ACT 8, for example, the processor 21 acquires the permission flag stored in the RAM 23. In a case where the permission flag indicates "1", the processor 21 determines that the permission information has been set. In this case, the processor 21 may determine that the fraud determination condition is not satisfied. In a case where the permission flag indicates "0," the processor 21 determines that the permission information has not been set.

In a case where the permission information has been set (ACT 8: YES), the processing shifts from ACT 8 to ACT 1. In this case, the processor 21 may permit the exit of the target object. For example, the processor 21 determines that the fraud determination condition with respect to the product registration is not satisfied. The processor 21 may determine that there is no fraud with respect to the product registration. In a case where the permission information has not been set (ACT 8: NO), the processing shifts from ACT 8 to ACT 9.

The processor 21 outputs a notification on the basis of the fact that the permission information has not been set (ACT 9). In ACT 9, for example, the processor 21 determines that the fraud determination condition with respect to the product registration is satisfied on the basis of the fact that the permission information has not been set. The processor 21 outputs a notification on the basis of a result of the fraud determination. For example, the processor 21 outputs a notification indicating that there is a fraud with respect to the product registration to the POS terminal 1. The POS terminal 1 acquires the notification from the fraud detection apparatus 2. The POS terminal 1 may display the notification on the touch panel 101 on the basis of the notification. The POS terminal 1 may auditorily output the notification via the loudspeaker 111. The POS terminal 1 may cause the alarm lamp 110 to light up or blink on the basis of the notification.

In this example, the fraud detection apparatus 2 performs the fraud determination with respect to the product registration, using the fact that there is no product registration information registered between the entry and the exit of the target object to/from the predetermined area and the permission information has not been set as a fraud determination condition.

According to this example, the fraud detection apparatus 2 is capable of acquiring detection information of the target object via the sensor interface 24, acquiring the product registration information via the communication interface 25, and performing the fraud determination with respect to the product registration on the basis of the detection information and the product registration information. For example, the fraud detection apparatus 2 detects the target object on the basis of the captured image captured by the camera 3. The fraud detection apparatus 2 is capable of determining whether or not there is a product registration omission on the basis of the detection result of the target object and the product registration information recorded by the POS terminal 1. Therefore, the fraud detection apparatus 2 can suitably detect the fraud in the product registration by performing the fraud determination with a combination of the detection information and the product registration information. Moreover, since the fraud detection apparatus 2 is capable of performing the fraud determination every time the fraud detection apparatus 2 detects the target object, the fraud detection apparatus 2 can determine whether or not there is a fraud in real time.

Moreover, the fraud detection apparatus 2 is capable of acquiring the product registration information including information indicating the type of the registration device in which the product has been registered and setting the permission information in accordance with the type of the registration device. For example, the fraud detection apparatus 2 is capable of determining whether or not the registration device in which the product has been registered is the fixed scanner and setting the permission information in a case where the product has been registered by a registration device different from the fixed scanner. Therefore, the fraud detection apparatus 2 is capable of setting the fraud determination condition in accordance with the type of the registration device. For example, in a case where the operator registers the product by a registration device different from the fixed scanner, such as a handheld scanner or a touch panel, the operator sometimes moves the product from the upstream side to the downstream side of the POS terminal 1 after the operator registers the product. The fraud detection apparatus 2 can be prevented from falsely detecting a fraud in a case where the registration device highly likely to register the product before the movement of the product is used by setting the permission information in accordance with the type of the registration device. Accordingly, the fraud detection apparatus 2 can suitably detect the fraud in the product registration. Moreover, the fraud detection apparatus 2 can be prevented from falsely detecting a fraud in the product registration.

Moreover, the fraud detection apparatus 2 is capable of outputting a notification on the basis of a result of the fraud determination. For example, in a case where the fraud detection apparatus 2 has determined that there is a fraud with respect to the product registration, the fraud detection apparatus 2 outputs a notification indicating that there is a fraud in the POS terminal 1. The POS terminal 1 is capable of outputting a notification via the loudspeaker 111 or the touch panel 101 and informing the operator of the POS terminal 1 of the fact that there is a fraud. The operator of the POS terminal 1 can easily recognize a fraud such as a product registration omission on the basis of the notification. Therefore, the fraud detection apparatus 2 can suppress the fraud in the product registration.

Moreover, the fraud detection apparatus 2 is capable of detecting the entry and exit of the target object to/from the predetermined area on the basis of the detection information. For example, the fraud detection apparatus 2 detects the entry and exit of the target object to/from the predetermined area on the basis of the captured image captured by the camera 3. Therefore, the fraud detection apparatus 2 is capable of determining the fraud with respect to the product registration on the basis of the timing at which the target object has entered the predetermined area, the timing at which the target object has exited the predetermined area, and the timing at which the product has been registered. For example, the fraud detection apparatus 2 is capable of determining that there is a product registration omission in a case where there is no product registration between the entry of the target object to the predetermined area and the exit of the target object from the predetermined area and the permission information has not been set. In this manner, the fraud detection apparatus 2 can suitably detect the fraud in the product registration. Moreover, the fraud detection apparatus 2 can be prevented from falsely detecting a fraud in the product registration.

For example, in a case where the target object is the hand of the operator of the POS terminal 1, the fraud detection apparatus 2 determines whether or not the hand of the operator of the POS terminal 1 has entered from the upstream side of the region corresponding to the predetermined area of the captured image on the basis of a result of the image recognition. Therefore, the fraud detection apparatus 2 is capable of determining a fraud by determining the entry and exit of the hand to/from the predetermined area. Since the fraud detection apparatus 2 predicts the movement of the product and determines a fraud by detecting the movement of the hand of the operator, the fraud detection apparatus 2 can suitably detect the fraud in the product registration. Moreover, since the fraud detection apparatus 2 only needs to detect the movement of the hand of the operator, the fraud detection apparatus 2 can reduce the load of the image recognition.

For example, in a case where the target object is a hand holding the product, the fraud detection apparatus 2 determines whether or not the hand of the operator of the POS terminal 1 is holding the object on the basis of a result of the image recognition. The fraud detection apparatus 2 determines whether or not it has entered from the upstream side of the region of the captured image, which corresponds to the predetermined area, in a state in which the hand of the operator of the POS terminal 1 is holding the object. Therefore, the fraud detection apparatus 2 is capable of determining a fraud by determining the entry and exit of the hand to/from the predetermined area holding the object. By determining a fraud on the basis of whether or not the hand of the operator is holding the object, the fraud detection apparatus 2 can be prevented from falsely determining a fraud in a case where the operator is not holding the product. Accordingly, the fraud detection apparatus 2 can more suitably detect the fraud in the product registration and suppress the false determination.

For example, in a case where the target object is an object such as a product, the fraud detection apparatus 2 recognizes whether or not the object is a product on the basis of a result of the image recognition. The fraud detection apparatus 2 determines whether or not the product has entered from the upstream side of the region of the captured image, which corresponds to the predetermined area. Therefore, the fraud detection apparatus 2 is capable of determining a fraud by determining the entry and exit of the product to/from the predetermined area. By determining a fraud on the basis of the product, the fraud detection apparatus 2 can be prevented from falsely determining a fraud in a case where something other than the product has passed the predetermined area. Accordingly, the fraud detection apparatus 2 can more suitably detect the fraud in the product registration and suppress the false determination.

In this manner, the fraud detection apparatus 2 is capable of performing the fraud determination with respect to the product registration on the basis of the fraud determination condition with respect to the product registration information based on the detection of the target object and the fraud determination condition related to the permission information. Therefore, the fraud detection apparatus 2 can suitably detect the fraud in the product registration.

### Modified Example

In the above-mentioned example, the case where the permission flag is used as the permission information has been described, though the permission information is not limited thereto. The permission information may be a permission counter. In the following example, a case where the permission information is a permission counter will be described. In this example, the RAM 23 stores the permission counter as the permission information.

For example, the permission counter is information indicating the number of permitting the entry and exit of the target object to/from the predetermined area. The permission counter may be information indicating the number of times the product has been registered by the registration device other than the fixed scanner. The permission counter is a numeric value for identifying the number of times the entry and exit of the target object to/from the predetermined area is permitted. The permission counter may be a numeric value for identifying the number of times the product has been registered by the registration device other than the fixed scanner. For example, the processor 21 increments the permission counter in a case where the entry and exit of the target object to/from the predetermined area are permitted. In a case where the entry and exit of the target object to/from the predetermined area are permitted, the processor 21 clears the permission counter. The clearing the permission counter includes setting the permission counter to "0." The processor 21 may increment the permission counter in a case where the product has been registered by the registration device other than the fixed scanner. The processor 21 may clear the permission counter in a case where the product has been registered by the fixed scanner.

The processor 21 may decrement the permission counter in a case where the target object has exited the predetermined area.

It should be noted that the processor 21 may increment the permission counter on the basis of the number of products registered by the registration device other than the fixed scanner. For example, in a case where the operator has registered a plurality of products via the handheld scanner 103 or the touch panel 101, the processor 21 may increment the permission counter multiple times. Incrementing multiple times means increasing the value of the counter multiple times. For example, in a case where the operator two products have registered via the handheld scanner 103 or the touch panel 101, the processor 21 may increment the permission counter twice. In a case where the target object is the hand holding the product or the product, the processor 21 may decrement the permission counter by the number of products on the basis of the number of products that have exited the predetermined area.

### Processing Example

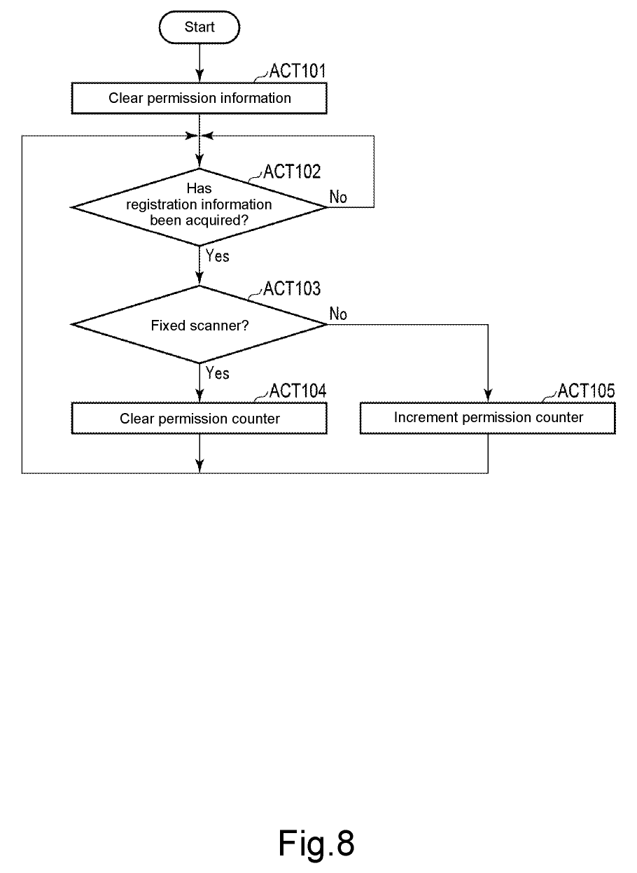

It should be noted that the processing procedure described below is merely an example, and each process may be modified as much as possible. Moreover, the steps may be omitted, substituted, or added as appropriate in accordance with the embodiment with respect to the processing procedure described hereinafter. FIG. 8 is a flowchart illustrating an information processing procedure related to setting of the permission information by the fraud detection apparatus 2 according to the embodiment.

The following processing is executed on the basis of the registration of the product started by the operator of the POS terminal 1. For example, the processor 21 detects the product registration start trigger. The processor 21 may acquire the start instruction on the basis of the input of the start instruction by the operator of the POS terminal 1 on the touch panel 101. The processor 21 may detect the product registration start trigger on the basis of the fact that the start instruction has been acquired.

The processor 21 starts the fraud detection processing on the basis of the detection of the product registration start trigger. The processor 21 clears the permission counter (ACT 101). In ACT 101, for example, the processor 21 sets the value of the permission counter to "0." The processor 21 saves the permission counter in the RAM 23.

The processor 21 determines whether or not the product registration information has been acquired (ACT 102). In ACT 102, for example, the processor 21 determines whether or not the product registration information has been acquired from the POS terminal 1 via the communication interface 25. In a case where the product registration information has been acquired (ACT 102: YES), the processing shifts from ACT 102 to ACT 103. In a case where the product registration information has not been acquired (ACT 102: NO), ACT 102 is repeated as the processing.

The processor 21 determines whether or not the registration device is the fixed scanner on the basis of the fact that the product registration information has been acquired (ACT 103). In ACT 103, for example, the processor 21 determines the type of the registration device on the basis of the acquired product registration information. In a case where the type of the registration device is the fixed scanner, the processor 21 determines that the registration device is the fixed scanner. In a case where the type of the registration device is a registration device different from the fixed scanner, the processor 21 determines that the registration device is not the fixed scanner.

In a case where the registration device is the fixed scanner (ACT 103: YES), the processing shifts from ACT 103 to ACT 104. In a case where the registration device is not the fixed scanner (ACT 103: NO), the processing shifts from ACT 103 to ACT 105.

The processor 21 clears the permission counter on the basis of the fact that the registration device is the fixed scanner (ACT 104). In ACT 104, for example, the processor 21 sets the value of the permission counter to "0." The processor 21 saves the permission counter in the RAM 23. Then, the processing returns to ACT 102.

The processor 21 increments the permission counter on the basis of the fact that the registration device is not the fixed scanner (ACT 105). In ACT 105, for example, the processor 21 increments the value of the permission counter by one. The processor 21 saves the permission counter in the RAM 23. Incrementing the permission counter is an example of setting the permission information. It should be noted that the processor 21 may increment the permission counter multiple times in a case where the product registration information indicates the registration of a plurality of products. The processor 21 sets the permission counter on the basis of the number of times of the product registration by the registration device different from the fixed scanner. Then, the processing returns to ACT 102.

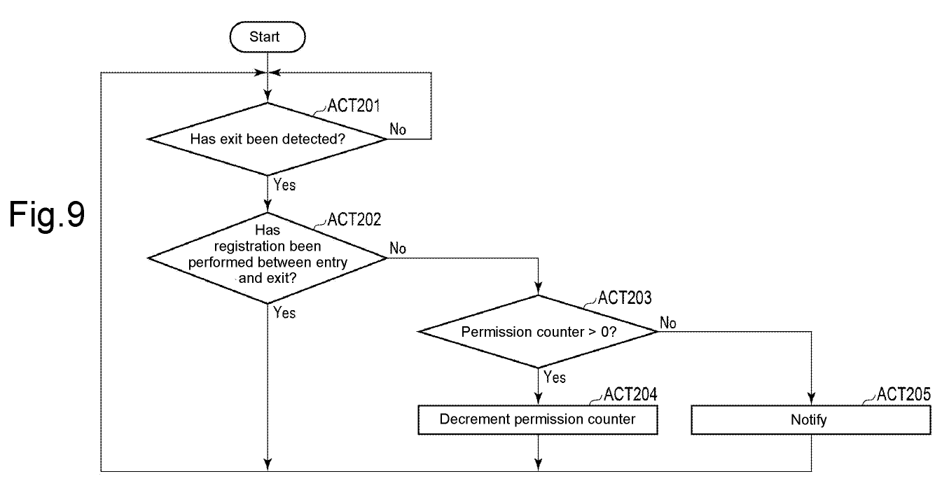

FIG. 9 is a flowchart illustrating an information processing procedure related to detecting a fraud by the fraud detection apparatus 2 according to the embodiment. The following processing is executed on the basis of the fact that the operator of the POS terminal 1 has started the registration of the product. The processor 21 acquires a captured image from the camera 3 via the sensor interface 24. For example, the processor 21 acquires a moving image.

As in ACT 6, the processor 21 detects the exit of the target object from the predetermined area on the basis of the captured image acquired from the camera 3 (ACT 201). In ACT 201, for example, the processor 21 determines whether or not the target object has exited from the downstream side of the predetermined area on the basis of the captured image. The processor 21 determines that the processor 21 has detected the exit of the target object from the predetermined area in a case where the processor 21 has detected that the target object has exited from the downstream side of the region of the captured image, which corresponds to the predetermined area.

In an example, the target object is a hand of the operator of the POS terminal 1. In another example, the target object is a hand of the operator of the POS terminal 1 holding the product. In still another example, the target object is an object such as a product.

In a case where the processor 21 has detected the exit of the target object from the predetermined area (ACT 201: YES), the processing shifts from ACT 201 to ACT 202. In a case where the processor 21 has not detected the exit of the target object from the predetermined area (ACT 201: NO), ACT 201 is repeated as the processing.

As in ACT 7, the processor 21 determines whether or not the product has been registered between the entry and the exit of the target object (ACT 202). In ACT 202, for example, the processor 21 determines whether or not there is product registration information registered between the entry detection time of the target object and the exit of the target object detection time. For example, the processor 21 acquires the product registration information stored in the RAM 23. The processor 21 determines whether or not the product registration has been performed between the entry detection time of the target object and the exit of the target object detection time on the basis of the product registration information.

In a case where there is product registration information registered between the entry detection time of the target object and the exit of the target object detection time, the processor 21 determines that the product has been registered between the entry and the exit of the target object. In a case where there is no product registration information registered between the entry detection time of the target object and the exit of the target object detection time, the processor 21 determines that the product has not been registered between the entry and the exit of the target object.

In a case where the product has been registered between the entry and the exit of the target object (ACT 202: YES), the processing returns from ACT 202 to ACT 201. In a case where the product has not been registered between the entry and the exit of the target object (ACT 202: NO), the processing shifts from ACT 202 to ACT 203.

The processor 21 determines whether or not the value of the permission counter is above 0 on the basis of the fact that the product has not been registered between the entry and the exit of the target object (ACT 203). In ACT 203, for example, the processor 21 acquires the permission counter stored in the RAM 23. The processor 21 determines whether or not the value of the permission counter is a value above 0. The fact that the value of the permission counter is the value above 0 is an example of the fact that the permission information has been set. In a case where the value of the permission counter indicates the value above 0 (ACT 203: YES), the processing shifts from ACT 203 to ACT 204. In a case where the value of the permission counter is not the value above 0 (ACT 203: NO), the processing shifts from ACT 203 to ACT 205.

The processor 21 decrements the value of the permission counter on the basis of the fact that the value of the permission counter is above 0 (ACT 204). In ACT 204, for example, the processor 21 may permit the exit of the target object on the basis of the fact that the value of the permission counter is above 0. The processor 21 determines that the fraud determination condition with respect to the product registration is not satisfied. The processor 21 may determine that there is no fraud with respect to the product registration. Then, the processing returns to ACT 201. It should be noted that in a case where the processor 21 has detected the exit of the hand holding the product or the product as the target object in ACT 201, the processor 21 may decrement the permission counter by the number of products on the basis of the number of products that have exited the predetermined area.

The processor 21 does not permit the exit of the target object on the basis of the fact that the value of the permission counter is the value above 0. The processor 21 determines that the fraud determination condition with respect to the product registration is satisfied. The processor 21 may determine that there is a fraud with respect to the product registration. The processor 21 outputs a notification on the basis of a result of the fraud determination. For example, the processor 21 outputs a notification indicating that there is a fraud to the POS terminal 1. The POS terminal 1 acquires the notification from the fraud detection apparatus 2. The POS terminal 1 may display the notification on the touch panel 101 on the basis of the notification. The POS terminal 1 may auditorily output the notification via the loudspeaker 111. The POS terminal 1 may cause the alarm lamp 110 to light up or blink on the basis of the notification. Then, the processing returns to ACT 201.

In this example, the fraud detection apparatus 2 performs the fraud determination with respect to the product registration, using the fact that there is no product registration information registered between the entry and the exit of the target object to/from the predetermined area and the permission counter is 0 as a fraud determination condition.

According to this example, in the fraud detection apparatus 2, effects similar to those in the case where the permission information is a permission flag are obtained.

Moreover, the fraud detection apparatus 2 is capable of setting the permission information on the basis of the number of registrations by the registration device different from the fixed scanner. For example, the fraud detection apparatus 2 is capable of setting the value of the permission counter during the product registration in accordance with the number of times the product has been registered by the registration device different from the fixed scanner. Therefore, the fraud detection apparatus 2 is capable of permitting the entry and the exit of the target object to/from the predetermined area in accordance with the number of times the product has been registered by the registration device different from the fixed scanner. For example, after the operator of the POS terminal 1 consecutively registers a plurality of products via the handheld scanner 103 or the touch panel 101, the operator sometimes moves the plurality of products from the upstream side to the downstream side of the POS terminal 1. The fraud detection apparatus 2 can suitably detect the fraud in the product registration also in a case where the number of times the products are registered and the number of times the products are moved are different, using the registration device different from the fixed scanner 115.

### Other Embodiments

In the above-mentioned embodiment, the example in a case of detecting the target object by the camera above the head has been described, though not limited thereto. The target object may be detected by a camera mounted on the fixed scanner 115 or an infrared sensor. The fraud detection apparatus 2 may detect the entry and exit of the target object to/from the predetermined area on the basis of detection information from the camera mounted on the fixed scanner 115 or the infrared sensor.

In the above-mentioned embodiment, the fraud detection apparatus 2 has been described taking the case where the permission information is set on the basis of the product registration information as an example, though not limited thereto. For example, the fraud detection apparatus 2 may set permission information that allows the target object to pass by the predetermined area while the operator of the POS terminal 1 is holding the handheld scanner 103. For example, the fraud detection apparatus 2 may detect that the operator is holding the handheld scanner 103 on the basis of the captured image acquired from the camera 3. The fraud detection apparatus 2 may set the permission information on the basis of the detection result.

The functions realized by the processor 21 described in the above-mentioned embodiment are not limited to those realized by a single apparatus, such as the fraud detection apparatus 2. Each function may be realized by information processing systems distributed in a plurality of apparatuses.

The above-mentioned embodiment may be applied to a single apparatus. The above-mentioned embodiment may be applied to a method executed by one or more apparatuses. The above-mentioned embodiment may be applied to a program capable of causing computers of one or more apparatuses to execute each function. The above-mentioned embodiment may be applied to a recording medium that stores the program.

Each of the one or more circuits that constitute the processing circuit executes one or more processes of the plurality of processes. In a case where the processing circuit is constituted by a single circuit, the single circuit executes all the plurality of processes. In a case where the processing circuit is constituted by a plurality of circuits, each of the plurality of circuits executes some of the plurality of processes. Some of the plurality of processes may be one of the plurality of processes or may be two or more of the plurality of processes. In a case where the processing circuit is constituted by the plurality of circuits, the plurality of circuits may be included in a single apparatus or may be distributed in a plurality of apparatuses.

The program according to the present embodiment may be delivered in a state stored in the apparatus according to the embodiment or may be delivered in a state not stored in the apparatus. In the latter case, the program may be delivered via a network or may be delivered in a state recorded on a recording medium. The recording medium is a non-transitory tangible medium. The recording medium is a computer-readable medium. The recording medium can take any form as long as it is a computer-readable medium capable of storing a program, such as a CD-ROM or a memory card.

While certain embodiments have been described, these embodiments have been presented by way of example only, and are not intended to limit the scope of the inventions. Indeed, the novel embodiments described herein may be embodied in various other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fraud detection apparatus that detects a fraud in a registration machine that stores product registration information in accordance with an operation for registering a product that is a transaction target, comprising:
a first interface that is capable of communicating with a sensor that detects a target object in a predetermined area of the registration machine;
a second interface that is capable of communicating with the registration machine; and
a processing circuit configured to
acquire detection information of the target object from the sensor via the first interface,
acquire the product registration information from the registration machine via the second interface, and
perform fraud determination with respect to the registration of the product on a basis of the detection information and the product registration information.

2. The fraud detection apparatus according to claim 1, wherein
the registration machine includes a registration device of a first type, which is fixedly provided to the registration machine itself, is operated for registering the product that is the transaction target, and inputs information about the product, and the registration machine is capable of inputting information about the product also by a registration device of a second type different from the first type being operated.

3. The fraud detection apparatus according to claim 2, wherein
the product registration information includes information indicating a type of the registration device, and
the processing circuit sets permission information in accordance with the type of the registration device.

4. The fraud detection apparatus according to claim 3, wherein
the processing circuit performs the fraud determination with respect to the registration of the product on a basis of the set permission information.

5. The fraud detection apparatus according to claim 2, wherein
the product registration information includes, for each transaction target product, information about date and time at which the product that is the transaction target is registered by the registration device, the type of the registration device operated for registering the product that is the transaction target, and information about the product that is the transaction target.

6. The fraud detection apparatus according to claim 5, wherein
the processing circuit determines whether or not the product has been registered on a basis of the product registration information and determines the type of the registration device on a basis of the product registration information.

7. The fraud detection apparatus according to claim 2, wherein
the product registration information includes the information indicating the type of the registration device, and
the processing circuit sets permission information on a basis of the number of registrations of the product by the registration device of the second type.

8. The fraud detection apparatus according to claim 1, wherein
the processing circuit outputs a notification on a basis of a result of the fraud determination.

9. The fraud detection apparatus according to claim 1, wherein
the processing circuit detects entry and exit of the target object to/from the predetermined area on a basis of the detection information.

10. A control method for a fraud detection apparatus that detects a fraud in a registration machine that stores product registration information in accordance with an operation for registering a product that is a transaction target, comprising:
acquiring detection information of a target object from a sensor via a first interface capable of communicating with the sensor that detects the target object in a predetermined area of the registration machine;
acquiring the product registration information from the registration machine via a second interface capable of communicating with the registration machine; and
performing the fraud determination with respect to the registration of the product on a basis of the detection information and the product registration information.
